(19) United States
(12) Patent Application Publication
(10) Pub. No.: US 2003/0103138 A1
(43) Pub. Date: Jun. 5, 2003

(54) Video security and control system

(75) Inventors: Pen Pross Assayag, Montreal (CA); Marc Ducharme, Ste-Therese (CA)

Correspondence Address: MERCHANT & GOULD PC, P.O. BOX 2903, MINNEAPOLIS, MN, 55402-0903, US

(73) Assignee: Inter-Cite Video Inc., Montreal (CA)

(21) Appl. No.: 10/167,854

(22) Filed: Jun. 11, 2002

(30) Foreign Application Priority Data
Dec. 3, 2001 (CA) 2,364,230

(51) Int. Cl. H04N 9/47; H04N 7/18

(52) U.S. Cl. 348/143

(57) ABSTRACT

A video security and control system for recording images in an area to be monitored where the area includes at least one entry point. The system includes at least one camera and a plurality of sensors, at least one of the sensors being located at the entry point. The system also includes a control and capture unit operatively connected to each of the cameras and sensors, the unit including at least one preset and an image capture device. When the sensors are triggered, the sensors send a signal to the control and capture unit which queue the signals. The control and capture unit sends a signal to each of the cameras to execute the preset in the order queued in order to capture an image taken by the camera at each of said preset. The present invention provides for a more efficient use of video storage and minimizes the hardware requirements in order to monitor an area.

### FIELD OF THE INVENTION

The invention pertains generally to video security and control systems. More specifically, the invention relates to the detection and storage of video and data information for the purpose of examining and investigating the details contained within such information.

### DESCRIPTION OF THE PRIOR ART

A typical video security system for a given area generally includes at least one camera linked to a monitor and a tape recorder for recording the images coming from the camera. A person, typically a security guard, monitors the screen in order to detect an event which would require his or her intervention. More sophisticated systems also include remote control means for remotely controlling a camera, such as changing its orientation, or zooming in on a person.

If the area which needs to be monitored is large, many cameras are required, increasing the toll on the staff monitoring the area.

Alternatively, some systems use wide-angle lenses, in combination with narrow-angle lenses in order to better focus on some specific areas.

In order to cut down on the magnetic tape required to store the images, some areas are also provided with sensors which will trigger the recording of the image when the sensor detects something, such as movement.

The main disadvantage with the prior art systems is that they are passive systems, and thus it is difficult to follow events in real time.

### SUMMARY OF THE INVENTION

It is an object of the present invention to provide a video security system which obviates the above-mentioned drawbacks in the prior art. In accordance with the invention, this object is achieved with a video security and control system for recording images in an area to be monitored. The area includes at least one entry point and the system includes at least one camera; at least one sensor and computer means operatively connected to each of the cameras and the at least one sensor. The computer means include at least one preset so that when the sensor is triggered, it sends a signal to the computer means and the computer means sends a signal to the at least one camera to execute the preset, the computer means capturing an image taken by said camera at said preset.

In another aspect of the invention, there is provided a video security and control system for recording images in an area to be monitored. The area includes at least one entry point and the system comprises at least one camera; a plurality of sensors, at least one of the sensors being located at the entry point; control and capture means operatively connected to each of the at least one camera and the sensors, the controlling capture means including at least one preset and image capture means, wherein when the sensors are triggered, the sensors send a signal to the control and capture means which queue said signals, and said control and capture means send a signal to each of said at least one camera to execute said preset in the order queued, in order to capture an image taken by said camera at each of the presets.

### BRIEF DESCRIPTION OF THE DRAWINGS

The present invention will be better understood after reading a description of a preferred embodiment thereof, made in reference to the following drawings in which:

FIG. 1 is a schematic representation of the major components with an overview of the system topology according to a preferred embodiment of the invention;

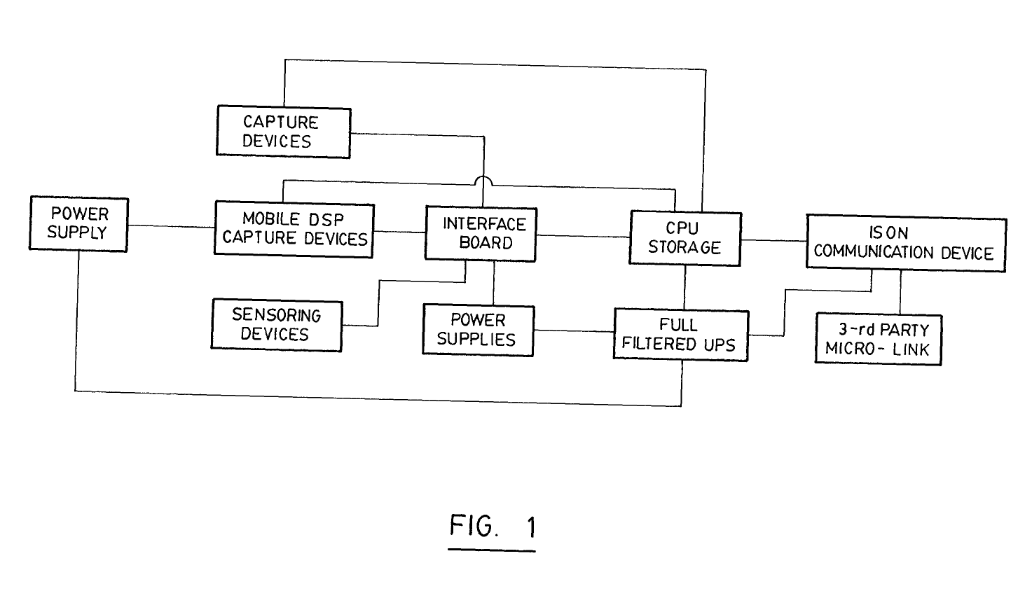

FIG. 2 is a schematic representation of a digital dome drive according to a preferred embodiment of the invention;

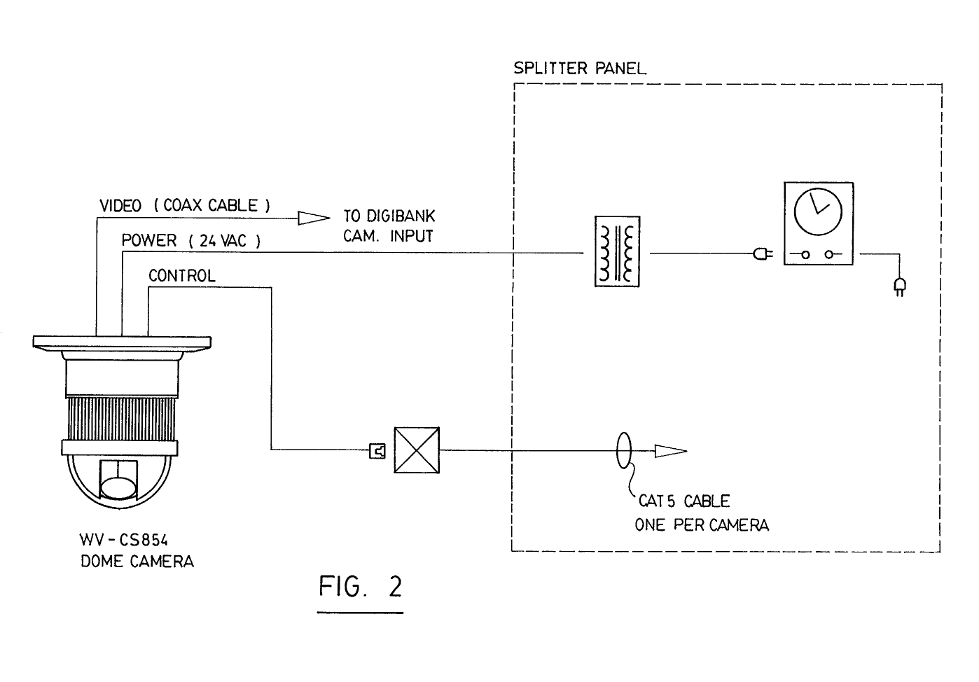

FIG. 3 is the alarm, power and dome drive communication interface board according to a preferred embodiment of the invention;

FIG. 4 is a schematic representation of the various components installed at a given location, in particular a bank branch.

### DESCRIPTION OF A PREFERRED EMBODIMENT OF THE INVENTION

Referring now to the appended Figures, the video security system of the present invention concerns detection, active capture, video and data digital storage and transmission components for the purpose of security and control applications.

The deployment of such organized components allows long term dedicated storage and analysis of events from remote locations with very specific content information.

The system includes unique detection and active capture capabilities, which allow it to perform ultra long-term storage of information. The system is further preferably provided with a high-speed communication link for remote retrieval and manipulation of data. This permits flexible evaluation of stored events and live remote control and programming applications.

The present invention possesses numerous benefits and advantages over known video systems, and more particularly, the ability to actively follow and capture events as they unfold in real time vs. the traditional passive capture approach. The flexbility of the method allows among other benefits to allocate capture device resources where required.

This interactive agility resolves the common shortfall of traditional storage devices which typically possess very short term storage ability. Another benefit is the elimination of multiple redundant image storage, which burns memory and slows the remote operation and evaluation of data.

The embedded active capture components are completely mobile with variable optical and digital zoom ratios, which allow dynamic integration at the usage site. This renders images of great detail and accurate event motion duplication. This effectively ends the traditional compromise between wide-angle images using too few capture devices with little detail or telephoto images with large system integration cost and complexity. Full-face identifiable face images are stored, substantially reducing the processing time, which saves on operating cost. Furthermore, in a preferred embodiment of the invention, the use of a single mobile dome engine reduces the amount of required capture devices in any given location for a lower cost and component count.

The present invention preferably employs radio frequency detectors and/or infrared sensors to precisely pinpoint events in a specific space, which eliminates the false alarms generated by video detection devices currently in use. Video motion detection is indiscriminate in its basic operating functions as it triggers the storage device to record image without necessarily capturing an actual event.

In addition to the foregoing attributes, the system possesses numerous other electrical and mechanical benefits over conventional systems. The high speed digital communications link (for example ISDN) gives the user a great improvement in access speed, seamless remote programming and control, fast event location and evaluation, secure non-public shared network and cost reductions over POTS based systems.

Other advantages of the combination of technologies of the present invention are as follows: eliminating tape and mechanical contact recording; removing operator processing of tapes, labelling, shipping, scheduling, recording and viewing; providing high resolution digital images with no anthropy; reducing required hardware and software resources compared to multiple camera set-ups, providing a digital system free of upward and downward conversions, thereby assuring the quality of images; removing multiplexing of images; actively recording events using intelligent scene analysis to detect, locate and process X, Y, Z co-ordinates for pinpoint precision and accurate event motion duplication; direct interfacing to digital integrated dome engines device for the active targeting of suspects (Super Dynamics II high speed mobile domes with direct drives); capability of acquiring full face shots and pan/scan information of perpetrators; providing for very long term storage of events, upward of eight months; providing an instant retrieval system using highspeed communications links; ensuring that every piece of recorded information is relevant, with no wasted frame recording, i.e. on demand recording; providing automated processing central with an IVR (interactive voice retrieval system); providing real time failure detection system with full remote diagnostics and dial up capability; providing a system with the capacity to continuously adapt to scene variations and to different site configurations.

The invention pertains to multiple hardware and software components integrated in a very specific fashion to perform complex motion sequences and storing functions, which precisely mimic an event for security and control applications.

Four main components make up a system according to the present invention: at least one sensor, at least one mobile or fixed capture devices (i.e. control and image capture means, a storage PC with a frame capture card and a high-speed communication link).

Hardware sensors, software sensors (or a combination of both) are strategically placed within the location to be monitored. The hardware sensors, which are based on the Doppler shift principle (microwave or infrared multi-lens beam sensors), are preferably located at different transaction-based areas such as service counters, reception desks, waiting areas, retail locations and secondary entryways.

Main entrance points are monitored using either the aforementioned Doppler sensor, N/O or N/C door contacts, infrared sensors or common REQ (request to exit) IR and microwave curtain mapping devices. The position and sensitivity of the Doppler devices are adjusted to reflect the monitored environment such as depth of detection and material density penetration, as when beaming through obstacle or non-metallic barriers. The IR sensors are adjusted to reflect the monitored environment by controlling the beam's surface coverage area.

Sensitivity adjustment is important for the present invention in that it must detect small or large objects moving at different speeds entering the field at various positions and ignore motion outside its detection parameters. This set-up is very important as it will signal the start of motion sequences from the digital dome drive and storing of data to the frame capture card. Understanding the shapes of the projected waves and the variance in coverage area with sensitivity adjustments promotes proper sensor use. Fringe area detection and associated reduction in performance are eliminated with hysteresis control and by the temperature stabilized components used in the Doppler detector.

The Doppler sensors employed are characterized by an open collector output, which is pulled up via a 1K resistor by the 5 Volt DC supply at the alarm input board. The microwave sensor is 12 Volts DC powered and features a RJ-11 leaded connector for interface to the RJ-11 jack. The RJ-11 jack is wired to the alarm input board via a cable. The IR sensors employed are characterized by a large multi-beam lens design which is pulled up via a 1K resistor by the 5 Volt DC powered and features a hard-wired screw-type terminal connection which is in turn wired to the alarm input board via a cable.

For every alarm input received a corresponding command string is initiated. This string is under firmware and software control, which is currently commonly available on the market. The string is sent via a RS-485 communication line to a digital dome drive. The dome drive utilized is the unitized type with PS data link, featuring 360 degree continuous pan rotation and 180 degree tilt capacity, 64 internal pre-sets each with definable location co-ordinates including zoom/focus and digital lighting management, minimum of 300 degree motion speed, colour ¼″ image capture device with the capacity for digital output and upload/download of parameters for service or dome drive replacements. The string is single or multiple pre-set number with an associated variable time duration; the start of the command string is the information regarding the dome unit address. The communications protocols and language are commonly available by the dome drive manufacturer. The actual X, Y, Z co-ordinates to which the pre-set refer to, are storage in EEPROM at the dome drive. The purpose of using the dome drive is to allow it, by using multiple pre-sets, to react continuously to triggered events. Should one look at motion imaging as many individual points on a continuum (either 30 frames/sec or 60 fields/sec) the effect of pre-sets at each defined point on that trajectory, is to duplicate the motion unfolding in front of the capture device. The execution of each assigned pre-set as required for every alarm input mimics the event with enough speed and agility to render a “concentrated” video capture. The programming of the dome drives is preferably executed via software designed to simplify the process using a Windows™ virtual basic environment. This software is advantageously loaded on a laptop to permit service personnel access to the dome drive control via an RS-232 to RS-485 converter card.

The software emulates in part the manufacturer's communication protocols and adds many useful features, such as full duplex communication, which allows a debug window to be opened for reading the return string sent by the dome drive. The software also performs specific upload and download archiving cycles for dome drive data retrieval. Among other features, it has the capacity to do complete camera control, access the internal dome drive set-up menu, offer a virtual keyboard, variable pan/tilt speed, pre-set call list, pre-set set menu, pan/tilt control, zoom/focus control, auto pre-set control for speedier pre-set storage, unit number dome drive selection, data sent and receive screen and variable programmable communication parameters.

By properly setting the pre-set position speed and aspect ratio in conjunction with sensors, it becomes possible to blanket a large area with a single dome drive. The programming of pre-sets and their respective allocation will reflect the success attained in capturing all events. In a preferred embodiment of the invention, after receiving a main entrance alarm, the dome will execute multiple pre-sets in concurrence with the expected motion of individuals within the projected path. Once the motion is tracked and captured, the individual will be again targeted as soon as he enters a new sensor zone and a new sequence of pre-sets will take over to reflect the new position programming allocation.

At other locations, such as an ATM (automated teller machines) or night deposits, fixed DSP cameras are embedded into the fascia of the units with proprietary lexan kits. These kits integrate the camera either in the night deposit box or within any current ATM. This kit comprises a lexan fascia colour matched to the ATM or night deposit, the lexan thickness being ¼″ with a surrounding ¼″ bevelled edge. For anti-vandal protection, four 10/32″ by 1 and ½″ long studs are heat forced ¼″ from each corner with no visible head. A flexible DSP board camera mounting assembly allows camera positioning for proper image capture. The four studs protruding from the rear of the apparatus support this assembly.

The Doppler sensor and/or IR sensors replaces traditional video motion detection at such locations to capture an actual transaction and ignore non-specific event activity.

In such applications DSP colour digital board programmable board cameras are used. Programming takes place through an interface module and a parallel port connection. It thus becomes possible to adjust individual cameras via a specific data cable to control variant scene conditions as to maintain uniform picture quality throughout the board DSP cameras and the digital dome drives. The extended power, video and data cable allows programming by technical service personnel outside of the ATM unit, as it does not require access to the internals of the ATM, which would put the unit offline.

The storage and capture device is PC based with hard drive storage through commonly available frame capture boards. The PC's serial port connects to an ISDN modem programmed for 128 Kb in bonding mode. This modem allows remote viewing, control and programming from any location. This high speed link permits seamless operator interface while in the remote live viewing mode, and also allows for complete remote diagnostics and programming to be performed with great speed in large deployment projects with multiple sites. This speed is required as with the advent of audio and remote control features where speed will ultimately be the limiting factor.

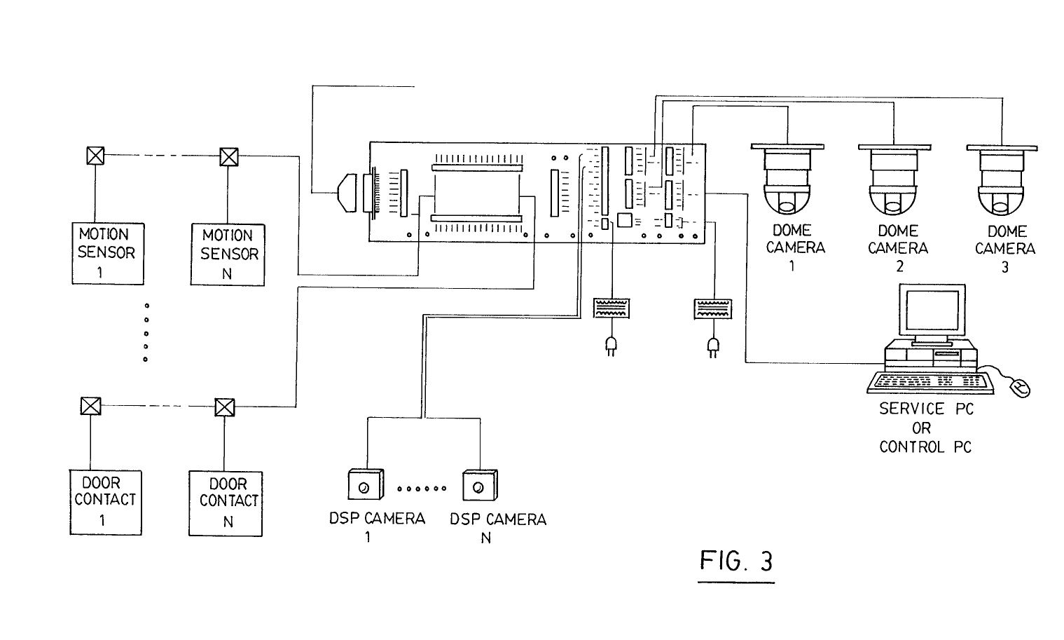

An alarm and distribution interface board shown in FIG. 3 allows up to 16 alarms and any number of sensors and fixed DSP cameras to be wired prior to connection with the main alarm input board. This board includes among other circuitry a buffer for interfacing with the digital dome drives, multiple jumper selection sections to isolate individual dome drives for troubleshooting work and multiple supervisory power supply circuits. This configuration, as will be apparent to a person skilled in the art, is not limitative and other configurations are well within the scope of the present invention.

An exemplary sequence of events will now be described.

The sequence of events starts when an individual enters through the main entrance doors or the secondary entry doors. The main door is wired with a pair of recessed door contacts either in NO or NC configuration (input type selectable in software). As the person opens the door, the signal from the contact points is sent to the alarm interface. Through software and firmware (where the actual dome engine communication protocols reside) the alarm activates multiple X, Y, Z coordinates or presets which were preprogrammed in the dome engine during the initial installation and setup phase, including the duration of the execution of each preset. The dome engine presets are set to replicate the position of the alarm and client with the distinct advantage of possessing the ability to set additional presets to match the person's projected path (through the doorway, down a set of stairs etc.,).

The first preset executed could for example be a telephoto frame of the person as he or she walks through the doorway, then one or more wide angle frames to capture the logical path. This guarantees identifiable frames of every suspect.

Every preset for the actual x, y and z coordinates is concurrently programmed for anticipated scene conditions such as zoom/focus ratios, iris or shutter control, character generation and so forth. This allows for high quality images to be captured, which are uniform and consistent in both the resolution and repeatability aspects.

At this point, as long as the door remains open the series of presets will be executed. This helps in capturing individuals that may “follow through” behind the first person. Generally, in a preferred embodiment of the invention, the dome engine associated with viewing the entryways are set to alarm priority. The reasoning behind such programming is the actual event at that location will most likely occur within a very small time frame, (in the order of 1 to 2 seconds). If this alarm were to be processed as a regular alarm and read through the alarm buffer, the event might actually be missed.

For all other events, such as transactions at a teller or CSR's the events usually run anywhere from 15 seconds to over several minutes (depending on the dynamics of the environment), thus allowing the buffer to empty and the dome engine to return and perform new alarm arrivals.

The entryways are also covered under priority alarms (executed prior to any other) as persons can always be captured at such a location for latter identification even though they did not eventually perform a transaction or any offence at a designated point.

In the case of entryways which do not utilize doors but employ rolling security doors which may result in entrances of the order of 10 to 25 feet wide, IR beams or multiple microwave sensors or IR sensors plated in the ceiling aiming towards the floor offer enough individual detection zones to allow presets to match specific entry points along the entrance.

Once the suspect passes the entry point and is captured, the system reverts to processing the remaining alarms put in queue by the priority of the door.

The person would then usually go to a reception area or a line up to wait being served. Secondary areas are sometimes programmed for capture by dome engines for specific security reasons; such decisions usually reflect the level of threat at that location.

Usually the next capture of the individual would occur at a transaction point (teller, CSR, pin machine etc.,). These points are zoned or mapped by microwave sensors or IR sensors in strategic positions to reflect the actual site dynamics and physical layouts.

Once a person enters a mapped area, an alarm is initially generated which is associated with a single or multiple preset. The dome engine executes the preprogrammed presets, which again take into consideration the area to be covered.

The original dome engine programming is done with software by entering all the motion, location, viewing ratios and scene controls into the dome engine memory. The technical personnel follow predetermined-programming parameters to follow such as max zoom ratio, size of secondary wide-angle shots and dome engine preset timing. Such programming mirrors the site dynamics, the security philosophy and the capacity of the system of the present invention.

The resultant information that was captured during the event, allows the system of the present invention to faithfully recreate the activity starting when the suspect entered through the main doors until he or she performed a transaction. It will be obvious that all images captured by the system of the present invention are appropriately time-stamped.

ATM machines are covered by having a programmable fixed DSP capture device installed into or near the fascia of the machine. One or more microwave sensor or IR sensors is used to locate the precise position of the suspect and when triggered, starts the preprogrammed capture sequence.

For ATM use, a cyclical (endless loop) buffer is utilized or pre-event recording. The DSP fixed capture device is positioned to render the best possible face images and is programmed by adjusting the DSP and EPROM maps to reflect lighting conditions and actual ATM position.

Night deposits are covered essentially in the same manner as the ATMs. The difference is in the amount and position of microwave sensors or IR sensors and sometimes the addition of night deposit door contacts. The addition of door contact allows with fixed DSP capture device placed inside the deposit to identify or confirm an actual deposit was done.

When ATM's or night deposits are exterior, the microwave sensors or IR sensors are installed in weatherized enclosures and are properly heated and ventilated via thermostat controls. The fixed DSP capture devices are similarly encased and protected from the elements.

In such a fashion using dome engines allows for the replacement of multiple fixed cameras. The practically infinite capability of the dome engine to view many locations within its line of sight results in complete coverage in the majority of situations. Additionally no physical limits are placed on the mobile engine such as in combination with fixed cameras and lenses. Furthermore, the use of sensors into pre-sets optimizes the storage of images, and provides for a very flexible system.

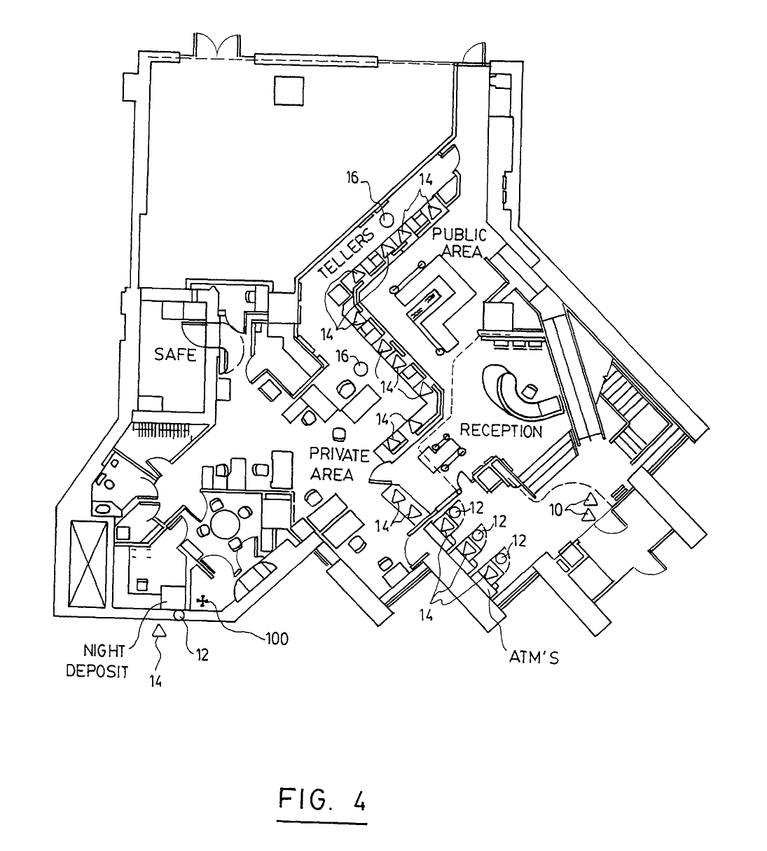

Referring now to FIG. 4, there is shown a typical location for which the system of the present invention is appropriate for surveillance. In this example, a bank has been chosen. Door contacts 10 are placed at the entrance. Fixed cameras 12 are placed at ATM locations, and microwave sensors 14 are placed at discrete locations, for example where tellers are located. Mobile cameras 16 or dome cameras are also placed at specific locations to follow and capture the movement of a person. Infrared sensors 18 can also be placed at various locations. The control and capture means 100 is connected to all the components and directs the cameras 16 based on inputs received from the various sensors.

Although the present invention has been explained hereinabove by way of a preferred embodiment thereof, it should be pointed out that any modifications to this preferred embodiment within the scope of the appended claims is not deemed to alter or change the nature and scope of the present invention. Specifically, the present invention is adaptable to locations such as banks, public buildings, etc.

1. A video security and control system for recording images in an area to be monitored, said area including at least one entry point, said system including:
at least one camera;
at least one sensor;
computer means operatively connected to each of said at least one camera and at least one sensor, said computer means including at least one preset, wherein when said sensor is triggered, said sensor sends a signal to said computer means, and said computer means sends a signal to said at least one camera to execute said preset, said computer means capturing an image taken by said camera at said preset.

2. A video security and control system for recording images in an area to be monitored, said area including at least one entry point, said system comprising:
at least one camera;
a plurality of sensors, at least one of said sensors being located at said entry point;
control and capture means operatively connected to each of said at least one camera and said sensors, said control and capture means including at least one preset and image capture means, wherein when said sensors are triggered, said sensors send a signal to said control and capture means which queue said signals, and said control and capture means send a signal to each of said at least one camera to execute said preset in the order queued, in order to capture an image taken by said camera at each of said preset.

3. A video security and control system according to claim 2, wherein said system includes one fixed camera, said camera being adapted to target a plurality of spots.

4. A video security and control system according to claim 3, wherein each of said spots correspond to a preset.

5. A video security and control system according to claim 4, wherein each preset includes pre-set position speed and aspect ratio.

6. A video security and control system according to claim 5, wherein when said sensor is triggered, said control and image capture means execute a plurality of presets for at least one trigger of a sensor.

7. A video security and control system according to claim 3, wherein said area further includes a plurality of service points, each of said service points being provided with a sensor.

8. A video security and control system according to claim 7, wherein said sensors provided at each of said service points are Doppler sensors or infrared sensors, or a combination thereof.

9. A video security and control system according to claim 7, wherein said control and image capture means queue said signals received from said sensors located at said entry points above signals received from other sensors.

10. A video security and control system according to claim 2, wherein said control and image capture meant further include a high speed communications link for remote monitoring of said system.

11. A video security and control system according to claim 6, wherein said plurality of presets for said at least one trigger of a sensor includes a zoom Image of said spot followed by a plurality of wide angle images of said spot.

12. A video security and control system according to claim 4, wherein said area to be monitored is a bank branch, and where said spots include said entry way, a plurality of teller locations and ATMs.

13. A video security and control system according to claim 3, wherein said camera is a dome camera.
